(19) United States
(12) Patent Application Publication
(10) Pub. No.: US 2016/0080298 A1
(43) Pub. Date: Mar. 17, 2016

(54) METHOD FOR GENERATING EMOTICON AND ELECTRONIC DEVICE SUPPORTING THE SAME

(71) Applicant: Samsung Electronics Co., Ltd., Suwon-si (KR)

(72) Inventors: Yangkyun Oh, Gunpo-si (KR); Jin Park, Suwon-si (KR)

(21) Appl. No.: 14/852,162

(22) Filed: Sep. 11, 2015

(30) Foreign Application Priority Data
Sep. 12, 2014 (KR) 10-2014-0121131

(51) Int. Cl. H04L 12/58; H04W 4/14

(52) U.S. Cl. CPC H04L 51/10; H04W 4/14; H04L 51/04

(57) ABSTRACT

Disclosed are a method for generating an emoticon and an electronic device supporting the same. The method includes dividing content into multiple image regions; extracting an image region corresponding to designated text among the multiple image regions; and generating an emoticon by using the extracted image region. Therefore, various emoticons, which are automatically generated by using various pieces of content, can be interestingly used.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2014-0121131, filed on Sep. 12, 2014, which is hereby incorporated by reference for all purposes as if fully set forth herein.

### TECHNICAL FIELD

The present disclosure relates to a method for generating an emoticon recommended based on the input text and an electronic device supporting the same.

### BACKGROUND

With the progress of functions of electronic devices, electronic devices have been variously utilized. For example, a text message transmission/reception function is a function capable of exchanging messages each including simple characters. Such a text message transmission or reception function is used to exchange text messages each including an emoticon (examples of the emoticon include a sticker, an image, a special character, an icon, etc.) as well as simple text according to the recent trend. When a user transmits or receives a text message, the user can utilize an emoticon and can have fun.

Such an emoticon attached to the text message may be produced by a content provider (a third party). Then, the produced emoticon is registered in a messaging service server, and is provided to the user.

A basic emoticon provided by the messaging service server is stored in the electronic device. Also, besides the basic emoticon, various emoticons downloaded by the user are stored in the electronic device.

The stored emoticon is displayed when the electronic device enters a separate emoticon input mode in a text message input mode. When a user input occurs and selects one of the multiple displayed emoticons, the selected emoticon is input. As a result, a text message including the selected emoticon is transmitted.

### SUMMARY

To address the above-discussed deficiencies, it is a primary object to provide basic emoticons to a user at the manufacturing stage. However, types of the basic emoticons are limited. Accordingly, a user feels tired of using the basic emoticons, and may not be interested in using the basic emoticons. In order to compensate for the disadvantages, support is provided in such a manner as to be capable of downloading and using an emoticon from a messaging service server. However, a process for downloading an emoticon is inconvenient to the user. Also, the user needs to select an emoticon desired by the user among emoticons recommended regardless of an input sentence among various emoticons. Accordingly, immediacy, which is a characteristic of an instant message, is hindered.

Accordingly, embodiments of the present disclosure provide a method and an apparatus which can analyze various pieces of content, such as an image and a moving image stored in an electronic device, through an Optical Character Reader (OCR), and can automatically generate particular content as an emoticon.

Also, embodiments of the present disclosure provide a method and an apparatus for searching and displaying, in real time, an emoticon corresponding to input text in a database storing an emoticon when the text is input in a text message input mode.

In accordance with an aspect of the present disclosure, a method for generating an emoticon in an electronic device is provided. The method includes dividing content into multiple image regions; extracting an image region corresponding to designated text among the multiple image regions; and generating an emoticon by using the extracted image region.

In accordance with another aspect of the present disclosure, a method for generating an emoticon in an electronic device is provided. The method includes generating, by a server, an emoticon based on stored content; storing the generated emoticon in an emoticon storage unit; receiving input text from the electronic device; searching for an emoticon corresponding to the input text; and transmitting an emoticon list, which includes at least one emoticon, to the electronic device according to a result of searching for the emoticon.

In accordance with still another aspect of the present disclosure, an apparatus for generating an emoticon is provided. The apparatus includes a server for dividing content into multiple image regions, extracting an image region corresponding to designated text among the multiple image regions, and generating an emoticon by using the extracted image region.

In accordance with yet another aspect of the present disclosure, an apparatus for generating an emoticon is provided. The apparatus includes a storage unit for storing the emoticon; a touch panel for detecting input of text in a text input window; a display panel for displaying the input text through the touch panel; a wireless communication unit for communicating with a server for searching for an emoticon corresponding to the input text; and a control unit for performing a control operation for receiving an emoticon list, which corresponds to the input text, from the server for dividing content into multiple image regions, extracting an image region corresponding to designated text among the multiple image regions, and generating an emoticon by using the extracted image region.

The method for generating an emoticon and the electronic device supporting the same, according to embodiments of the present disclosure, can automatically generate various emoticons by using the stored content. Then, the multiple generated emoticons can be displayed in such a manner as to correspond to the input text without a separate download process. Accordingly, the electronic device can provide various emoticons to the user, and can provide convenience by displaying an emoticon corresponding to the input text even when the electronic device does not enter a separate emoticon input mode.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system using a generated emoticon according to various embodiments of the present disclosure;

FIG. 2 illustrates a configuration of an electronic device supporting the input of an emoticon according to various embodiments of the present disclosure;

FIG. 3A and FIG. 3B illustrate a process for generating an emoticon according to various embodiments of the present disclosure;

FIGS. 4A to 4D illustrate an example of generating an emoticon according to various embodiments of the present disclosure;

FIG. 5 illustrates a process in which an electronic device uses an emoticon generated by a server according to various embodiments of the present disclosure;

FIGS. 6A to 6F illustrate examples of screens for explaining a process in which an electronic device uses an emoticon generated by a server according to various embodiments of the present disclosure;

FIG. 7 illustrates a process in which an electronic device, which receives a text message as input, uses a generated emoticon according to various embodiments of the present disclosure; and

FIG. 8 illustrates a process in which an electronic device uses a generated emoticon according to another embodiment of the present disclosure.

### DETAILED DESCRIPTION

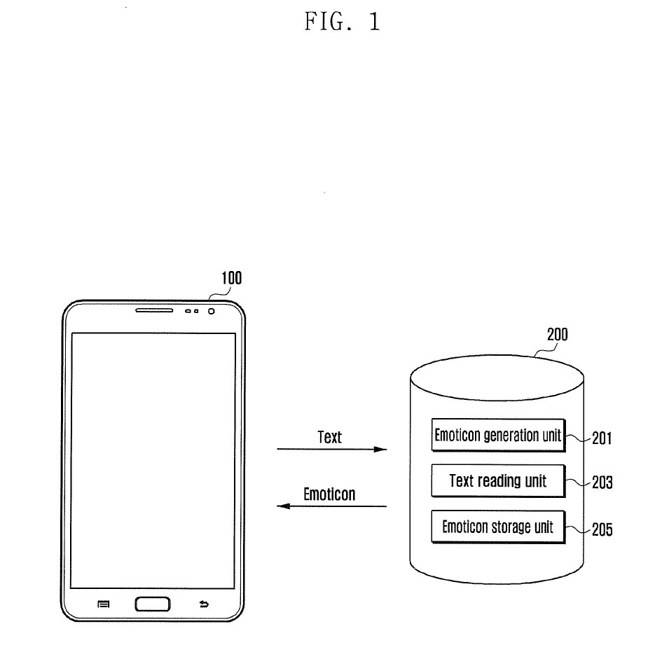

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system. Hereinafter, various embodiments of the present disclosure will be described in detail with reference to the accompanying drawings. It should be noted that the same elements will be designated by the same reference numerals although they are shown in different drawings. Further, in the following description of the present disclosure, a detailed description of known functions and configurations incorporated herein will be omitted when it may make the subject matter of the present disclosure rather unclear. Hereinafter, it should be noted that only the descriptions will be provided that may help understanding the operations provided in association with the various embodiments of the present disclosure, and other descriptions will be omitted to avoid making the subject matter of the present disclosure rather unclear.

In the following description, the term “emoticon” may be an image which is recommended to more richly express an emotion in a text message input window. An image, which is similar to a meaning signified by the input text, may be recommended as an emoticon. Each emoticon is stored in the form of a unique representative value and a designated image file name. An image file of the emoticon may have various picture file extensions, such as jpg, png, tif, jpeg, and the like.

In the following description, the term “content” is a source provided in order to generate an emoticon. For example, content according to various embodiments of the present disclosure is an electronic book (e-book) (e.g., a comic book, a magazine, a newspaper, etc.) stored in a server or an electronic device or is a moving image. For example, a comic book in the form of an e-book includes multiple pages, and a moving image includes multiple pages, such as a still image, a still cut, a scene, and the like.

FIG. 1 is a view illustrating a system using a generated emoticon according to various embodiments of the present disclosure.

Referring to FIG. 1, the system using the generated emoticon includes an electronic apparatus 100 that uses the generated emoticon, and a server 200 that generates an emoticon.

The electronic device 100 supports a function capable of recommending at least one generated emoticon corresponding to input text when a text message is input. Also, the electronic device 100 detects the selection of one of the recommended emoticons. When detecting the selection of the one emoticon, the electronic device 100 displays the selected emoticon in a text message input window.

When a send button is pressed, the electronic device 100 transmits, to a reception electronic device, the input text and/or emoticon together. In the present example, a process for pressing the send button is omitted. Specifically, when an event for selecting an emoticon occurs, the electronic device 100 transmits, to the reception electronic device, the input text and/or emoticon.

Accordingly, the electronic device 100 provides convenience to a user by reducing the length of an input process.

In various embodiments, the electronic device 100 is a reception electronic device. In certain embodiments, the electronic device 100 receives a message, which includes an emoticon, from another electronic device.

In another embodiment, the electronic device 100 is an electronic device that generates an emoticon. A process for generating an emoticon will be subsequently described in this specification.

The server 200 includes an emoticon generation unit 201, a text reading unit 203, and an emoticon storage unit 205. The emoticon generation unit 201 generates an emoticon by using an image and a moving image stored in the server 200. More specifically, the emoticon generation unit 201 analyzes content, such as an image, a moving image, and the like stored in the server 200 (or the electronic device 100), by using the text reading unit 203. As a result of the analysis, the emoticon generation unit 201 extracts content that satisfies an emoticon generation condition in which the content is capable of being generated as an emoticon among the pieces of content stored in the server 200. Then, the emoticon generation unit 201 generates the extracted content as an emoticon.

When the emoticon generation unit 201 analyzes the content stored in the server 200 (or the electronic device 100), the text reading unit 203 analyzes text included in the content by using optical technology. For example, the text reading unit 203 is an OCR.

The emoticon storage unit 205 stores the emoticon generated by the emoticon generation unit 201.

The above-described configuration of the server 200 is included in the electronic device 100, and the electronic device 100 also generates an emoticon. However, with reference to FIG. 1, a case is considered and described in which the electronic device 100 receives text as input, the server 200 analyzes the stored content and automatically generates an emoticon, and the server 200 is an electronic device that provides an emoticon corresponding to text which is input to the electronic device 100.

The electronic device 100 detects the input of text. When the input of text occurs, the electronic device 100 displays the input text in a text input window. Also, in a state of displaying the input text in the text input window, the electronic device 100 transmits text, which is input at a certain time point, to the server 200. For example, whenever text is completed in a unit of word spacing and in a unit of syllable, the electronic device 100 transmits the input text to the sever 200. Accordingly, the electronic 100 transmits, in real time, the input text to the sever 200.

As still another example, the electronic device 100 transmits, to the server 200, text that is input at a time point of occurrence of an event (e.g., an input event, such as a search button, a send button, etc.) for searching for the input text.

When receiving the input text from the electronic device 100, the server 200 searches for an emoticon corresponding to the input text in the emoticon storage unit 205. Then, when the emoticon corresponding to the input text exists, the server 200 transmits, to the electronic device 100, an emoticon list including the emoticon corresponding to the input text.

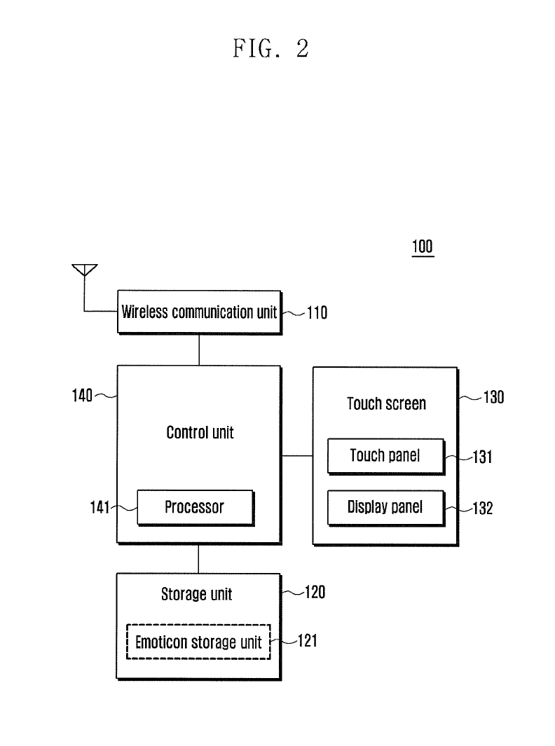

FIG. 2 is a block diagram illustrating a configuration of an electronic device supporting the input of an emoticon according to various embodiments of the present disclosure.

Referring to FIG. 2, the electronic device 100 includes a wireless communication unit 110, a storage unit 120, a touch screen 130, and a control unit 140.

The wireless communication unit 110 includes one or more modules that enable wireless communication between the electronic device 100 and a wireless communication system, or between the electronic device 100 and a network in which another electronic device is located. For example, the wireless communication unit 110 includes a mobile communication module, a Wireless Local Area Network (WLAN) module, a short-range communication module, a location calculation module, a broadcast receiving module, and the like.

Particularly, in embodiments of the present disclosure, the wireless communication unit 110 receives an emoticon, which corresponds to the input text, in real time from an emoticon storage unit 121. In various embodiments, when text is input, the wireless communication unit 110 communicates with the server 200 in order to search for the emoticon corresponding to the input text.

The storage unit 120 stores a program for the electronic device 100. The storage unit 120 stores data that is generated according to the operation of the electronic device 100 or is received from an external device through the wireless communication unit 110. The storage unit 120 includes a buffer as a unit for temporarily storing data. The storage unit 120 stores various pieces of setup information (e.g., a screen brightness, whether vibration is generated when a touch occurs, whether a screen is automatically rotated, etc.) for setting up a use environment of the electronic device 100. Under the control of the control unit 140, the storage unit 120 stores information, such as all icons, a font, and the like for displaying a partial image, such as time information, data information, battery information, text reception information, telephone reception information, and the like.

Particularly, in embodiments of the present disclosure, the storage unit 120 includes the emoticon storage unit 121. The storage unit 120 stores content that enables the generation of an emoticon. Also, under the control of the control unit 140, the emoticon storage unit 121 stores an emoticon generated based on content. The emoticon storage unit 121 is included in the server 200 illustrated in FIG. 1, as a basic example. However, in order to increase a speed at which a search is made for an emoticon corresponding to the input text, a predetermined part of the emoticon storage unit 121 is included in the electronic device 100.

The touch screen 130 includes a touch panel 131 and a display panel 132.

The touch panel 131 is installed on the screen of the touch screen 130. The touch panel 131 detects a user input on the screen. The touch panel 131 generates detection information in response to a user input and delivers the generated detection information to the control unit 140.

Particularly, in embodiments of the present disclosure, the touch panel 131 detects a user input for inputting a text message. Also, the touch panel 131 detects a user input for selecting at least one emoticon in a state of displaying an emoticon corresponding to the input text. The touch panel 131 delivers the detected user input to the control unit 140.

The display panel 132 is implemented by a Liquid Crystal Display (LCD), an Active Matrix Organic Light Emitted Diode (AMOLED) display, a flexible display, and/or a transparent display.

Particularly, in embodiments of the present disclosure, the display panel 132 displays text, which is input from the user, in a text message input window. Also, the display panel 132 displays an emoticon list including an emoticon corresponding to the input text. Then, the display panel 132 displays an emoticon selected by the user.

As described above, the display panel 132 displays text that is input to the text message input window, text and/or an emoticon to be transmitted, the received text and/or emoticon.

The control unit 140 controls an overall operation of the electronic device 100. The control unit 140 includes a processor 141. The processor 141 includes an Application Processor (AP), a Communication Processor (CP), a Graphic Processing Unit (GPU), and an audio processor. In the present example, the CP is an element of a cellular module of the wireless communication unit 110.

When a text message is input, the processor 141 implements a method for displaying an emoticon list corresponding to the input text. The emoticon list includes at least one emoticon corresponding to the input text. Hereinafter, a detailed description will be made of a method for generating an emoticon and supporting the generated emoticon according to various embodiments of the present disclosure.

Meanwhile, the electronic device 100 further includes elements, which have not been described above, such as an ear jack, a proximity sensor, an illuminance sensor, a Global Positioning System (GPS) receiving module, a speaker, a microphone, and the like. Also, the electronic device 100 further includes an interface unit for a wired connection with an external device. The interface unit is connected to the external device through a wire (e.g., a Universal Serial Bus (USB) cable). Accordingly, the control unit 140 data-communicates with the external device through the interface unit.

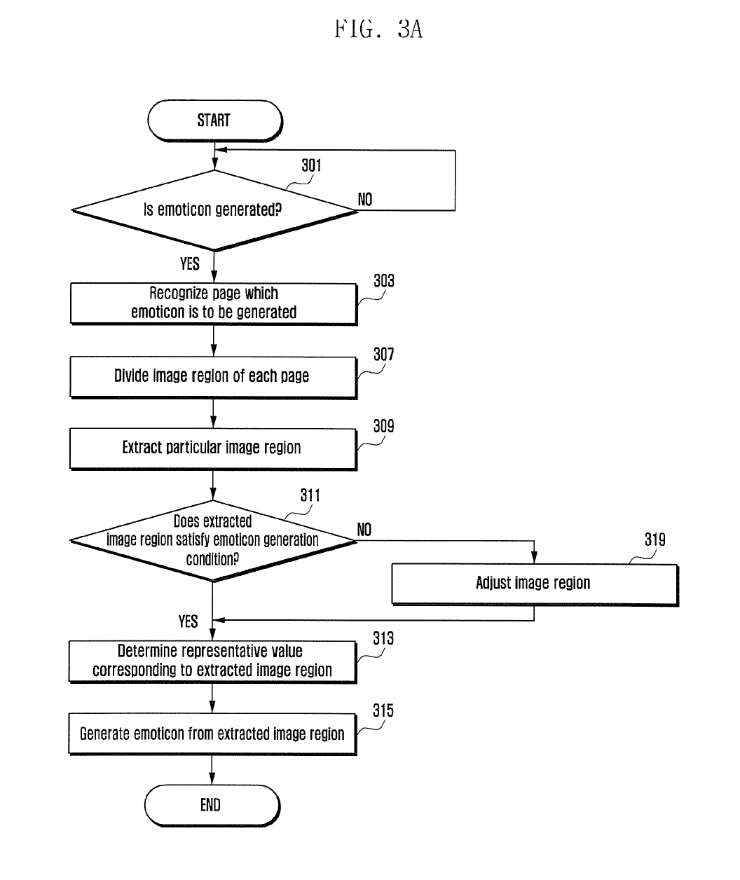

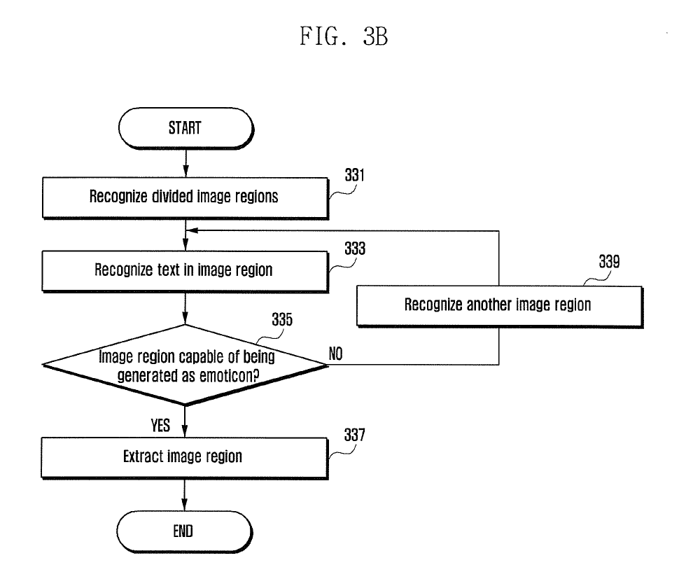

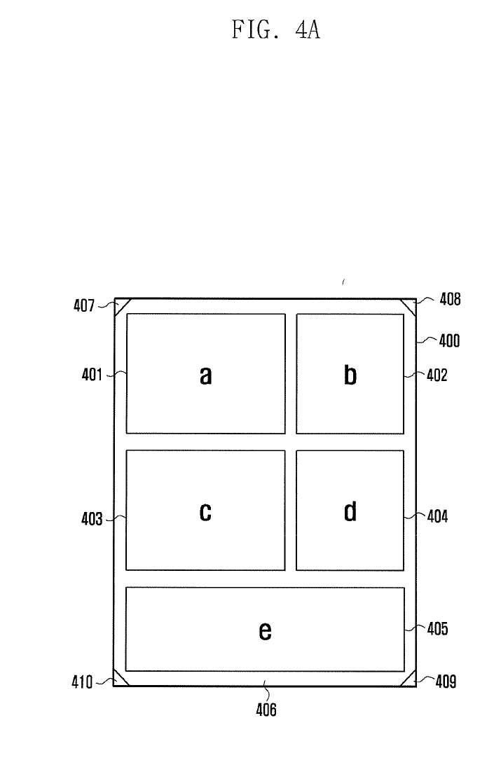

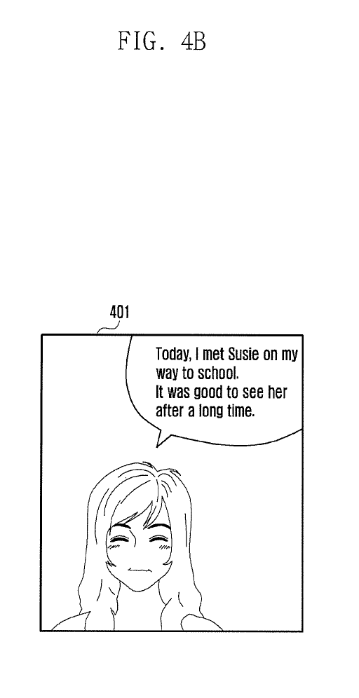

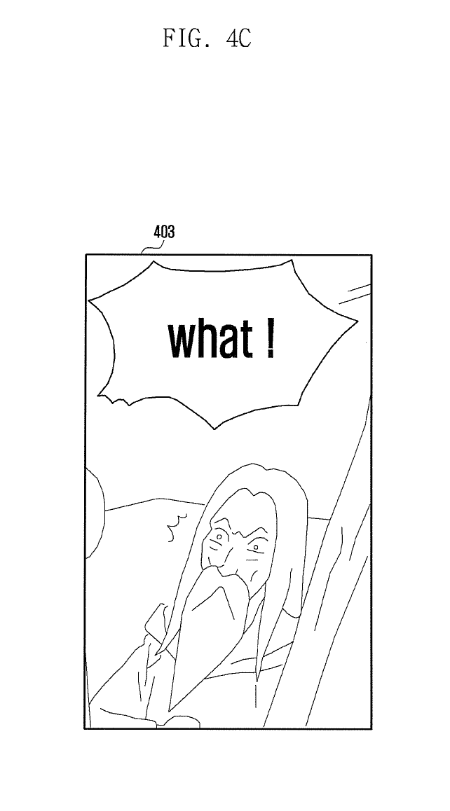

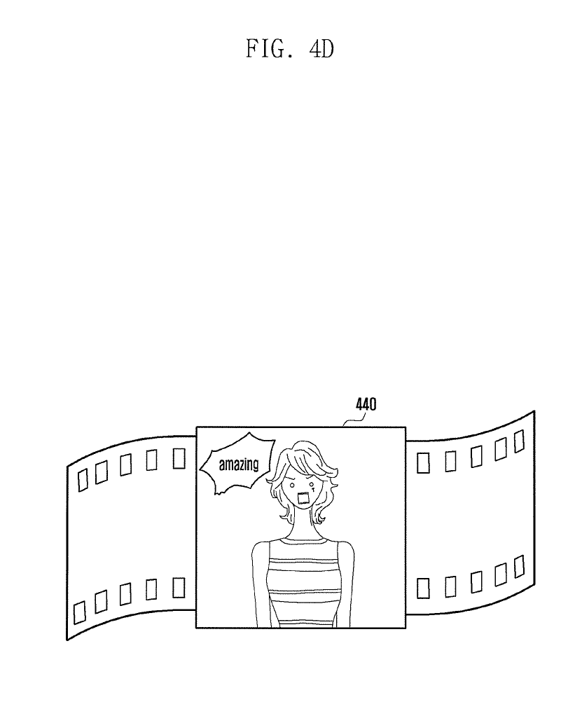

FIG. 3A and FIG. 3B are flowcharts illustrating a process for generating an emoticon according to various embodiments of the present disclosure. FIGS. 4A to 4D are examples of screens for explaining an example of generating an emoticon according to various embodiments of the present disclosure.

Referring to FIG. 1, FIG. 3A, and FIGS. 4A to 4D, in operation 301, the server 200 determines whether an event for initiating the generation of an emoticon occurs. The server 200 stores content which enables the generation of an emoticon. When the event occurs (e.g., when content is newly stored or is selected by a manager), the server 200 initiates the generation of an emoticon. The server 200 determines that the new content is an origin of an emoticon. The content is, for example, a comic book in the form of an e-book, a moving image, and the like.

A case will be described in which the content is a comic book. The comic book includes multiple volumes. In the comic book including multiple volumes, each volume includes multiple pages.

In operation 303, the server 200 recognizes a page that enables the generation of an emoticon. Specifically, the server 200 makes a list of multiple pages that forms the content and recognizes the list as a task subject page list. The task subject page list is generated such that the server 200 performs a task for identifying text included in a page through the text reading unit 203. Typically, the task subject page list is in the form of a file obtained by collecting image files (e.g., jpg, png, gif, pdf, etc.). The text reading unit 203 individually recognizes at least one image region (e.g., a cut, an illustration, a frame, a scene, etc.) included in each page in the task subject page list. For example, a task subject page includes multiple image regions 401, 402, 403, 404 and 405 as indicated by reference numeral 400 in FIG. 4A.

In operation 307, the server 200 divides an image region included in each page. Image division is performed in the following process. The emoticon generation unit 201 of the server 200 recognizes a background color on each page. For example, as illustrated in FIG. 4A, the emoticon generation unit 201 recognizes that a background 406 on a page 400 is white in color. The emoticon generation unit 201 identifies a color distribution at designated positions (e.g., four corners 407, 408, 409 and 410) on the page. The emoticon generation unit 201 recognizes a color, of which the distribution appears most frequently, as a background color of the page. For example, the corners 407, 408 and 409 is all white in color, and the corner 410 is yellow in color. At this time, the emoticon generation unit 201 recognizes that the background 406 is white in color. In the view illustrating the above-described example, the four corners 407, 408, 409 and 410 are illustrated as having regions thereof in order to help the understanding of the view. However, embodiments of the present disclosure are not limited thereto.

Thereafter, the emoticon generation unit 201 recognizes a boundary color of an image region on the basis of the determined background color. In various embodiments, the emoticon generation unit 201 scans inwards from each side region of the relevant page and identifies the color of a pixel and recognizes a color, which is different from the background color and simultaneously and continuously appears, as a boundary color for cutting an image region. For example, the emoticon generation unit 201 distinguishes between colors of pixels by using a pixel value that each color has. Specifically, when the background 406 is white in color, the emoticon generation unit 201 identifies that a pixel value of the background color is equal to zero. When it is continuously identified that a pixel value of the background color is equal to 100, the emoticon generation unit 201 recognizes the color of the background 406, which is different from the background color and simultaneously and continuously appears, as a boundary color. For example, the emoticon generation unit 201 recognizes that a black color corresponding to a pixel value of 100 is a boundary color. Accordingly, an image region is divided on each page, with a region 408, in which the background color is different from the boundary color, as a reference.

In operation 309, the server 200 extracts a particular image region capable of being generated as an emoticon among the divided image regions 401, 402, 403, 404 and 405 by using the text reading unit 203. In the present example, the image region capable of being generated as an emoticon is a region in which a sentence, which is included in a speech bubble among cuts included in a comic book, includes a short sentence (e.g., an exclamation, an onomatopoetic word, a mimetic word, a sentence with two syntactic words or less, etc.). The server 200 analyzes the divided image regions by using the text reading unit 203. Then, according to a result of the analysis, the server 200 extracts the particular image region determined to be capable of being generated as an emoticon among the divided image regions.

More specifically, referring to FIG. 3B, in operation 331, the server 200 recognizes the respective divided image regions. In operation 333, the server 200 recognizes text included in the image region by using the text reading unit 203. In operation 335, according to a result of recognizing the text, the server 200 determines whether the image region is capable of being generated as an emoticon.

When the image region is not capable of being generated as an emoticon, in operation 339, the server 200 recognizes another image region. Specifically, the server 200 recognizes text in another image region by using the text reading unit 203. For example, when a long sentence is represented by a speech bubble as in the image region 401 illustrated in FIG. 4B, the server 200 recognizes another image region. In other words, the server 200 may not extract the image region 401 as an image region for generating an emoticon.

Meanwhile, when recognizing the image region capable of being generated as an emoticon, in operation 337, the server 200 extracts the recognized image region as an image region enabling the generation of an emoticon. For example, when text included in a speech bubble is the exclamation “wow” as illustrated in FIG. 4C, the server 200 extracts the particular image region 403 for generating an emoticon. As described above, the text reading unit 203 detects the particular image region 403 capable of being generated as an emoticon among the divided image regions. At this time, the server 200 extracts the particular image region detected by the text reading unit 203.

As various embodiments, a case will be described in which content is a moving image. The server 200 recognizes a moving image including multiple frames (still images or pages). Each of the frames forming the moving image is in a state where each of the frames is divided by the server 200. Then, the server 200 recognizes text in each frame by using the text reading unit 203. Then, the server 200 extracts the particular image region 400 capable of being generated as an emoticon among the frames forming the moving image. For example, the server 200 extracts the frame (i.e., the image region) 440 including the text “amazing” as illustrated in FIG. 4D.

In operation 311, the server 200 determines whether the extracted image region satisfies an emoticon generation condition. The emoticon generation condition is, for example, a condition that text needs to be included in the extracted image region, a condition that an object (e.g., a figure, an animal, a character, etc.) needs to be included in the extracted image region, a condition that the size of the object is smaller than or equal to a predetermined size, and the like. When the emoticon generation condition is satisfied, in operation 313, the server 200 determines a representative value corresponding to the extracted image region. When a text message is written, a representative value corresponding to an image region is used as a key value for searching for an emoticon corresponding to text. One or more similar images are determined to have one representative value. Such an operation of determining a representative value is performed before operation 311 of determining whether the emoticon generation condition is satisfied.

Meanwhile, when the extracted image region does not satisfy the emoticon generation condition, in operation 319, the server 200 performs a control operation for adjusting an image region. The server 200 adjusts, for example, the size of the image region, the transparency thereof, the color thereof, and the like.

When the representative value of the image region has been determined, in operation 315, the server 200 generates an emoticon from the extracted image region. The server 200 generates an emoticon by adjusting the size of the image region to a predetermined size, the transparency thereof, the color thereof, and the like. The server 200 stores the extracted image region as an image file. When storing an image file, the server 200 stores the image file under the representative value and an image file name corresponding to the representative value.

The generated emoticon is stored in the emoticon storage unit 205. According to various embodiments of the present disclosure, the emoticon storage unit 205 is included in the electronic device 100.

As described above, the server 200 generates an emoticon through a process for generating an emoticon. Alternatively, according to circumstances, the electronic device 100 generates an emoticon through the above-described process.

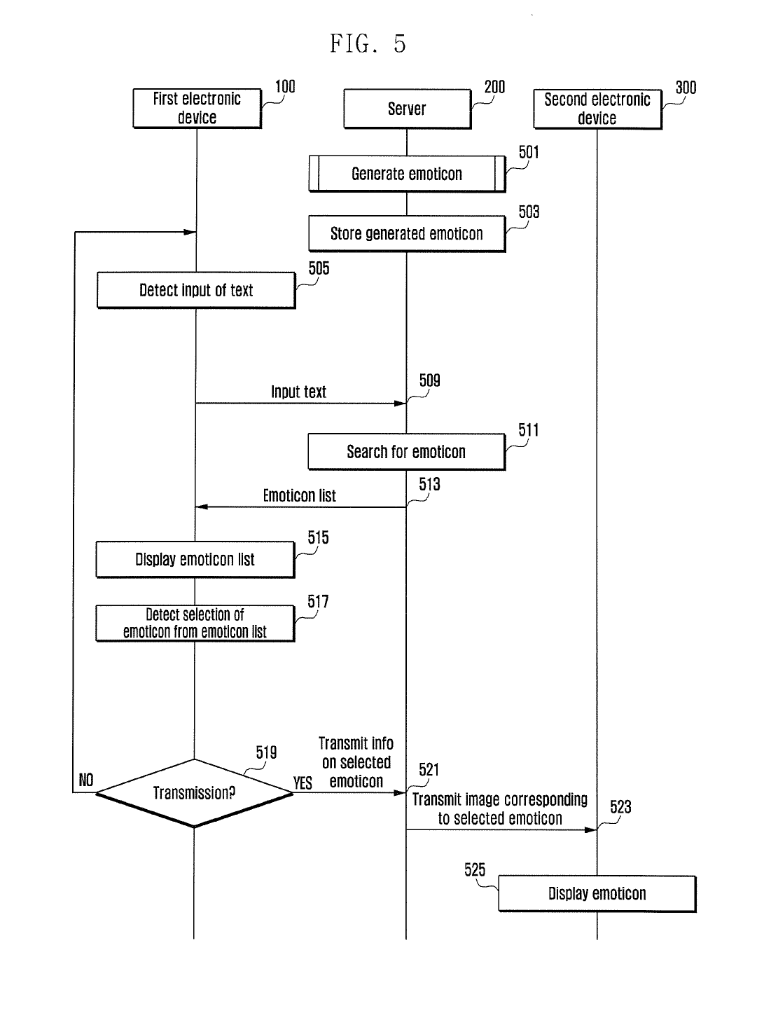

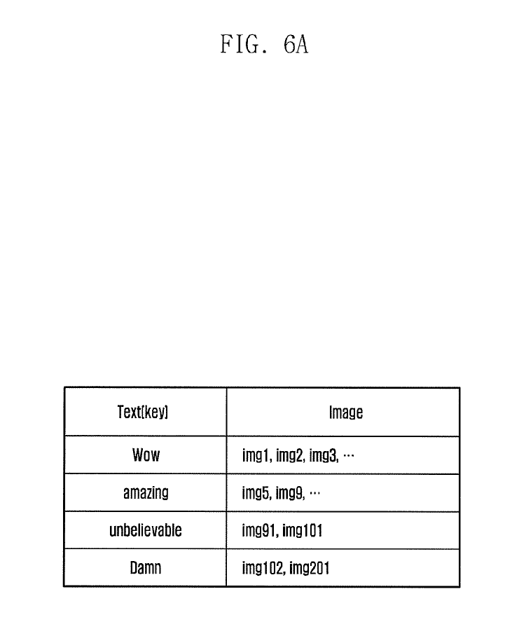

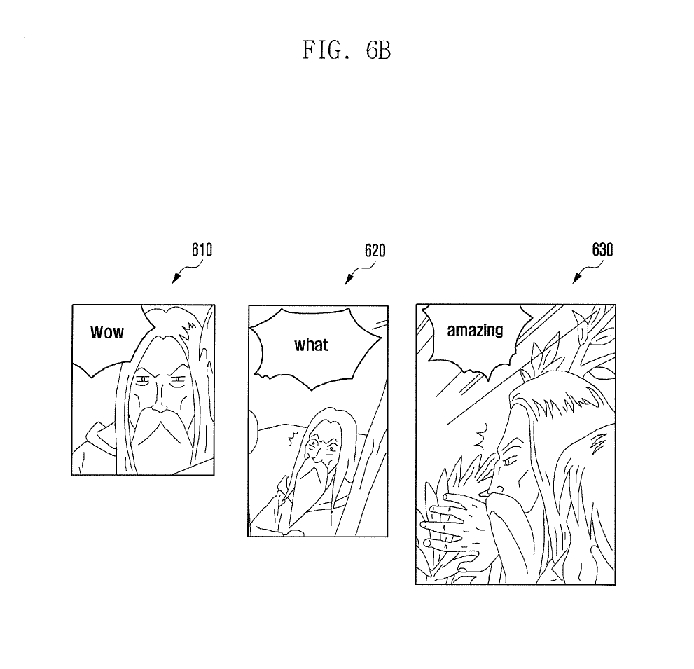

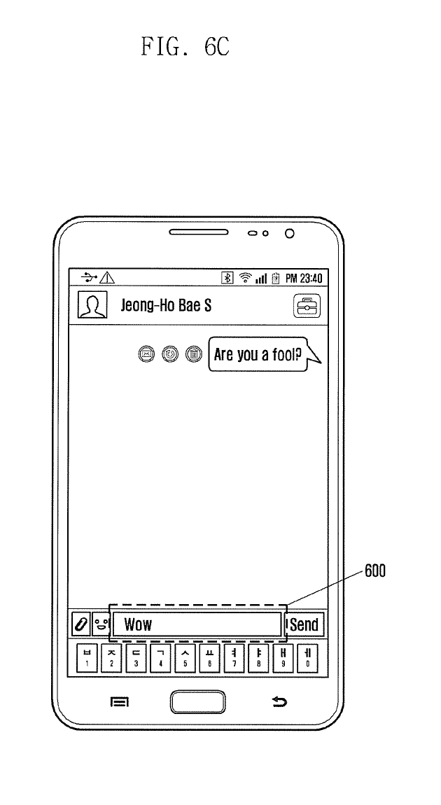

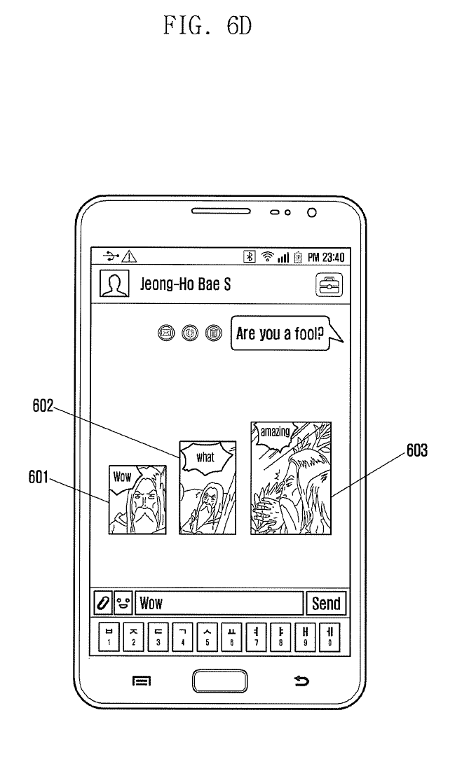

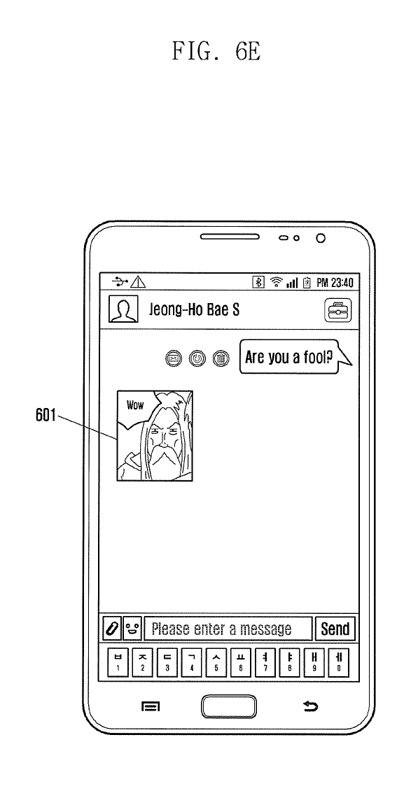

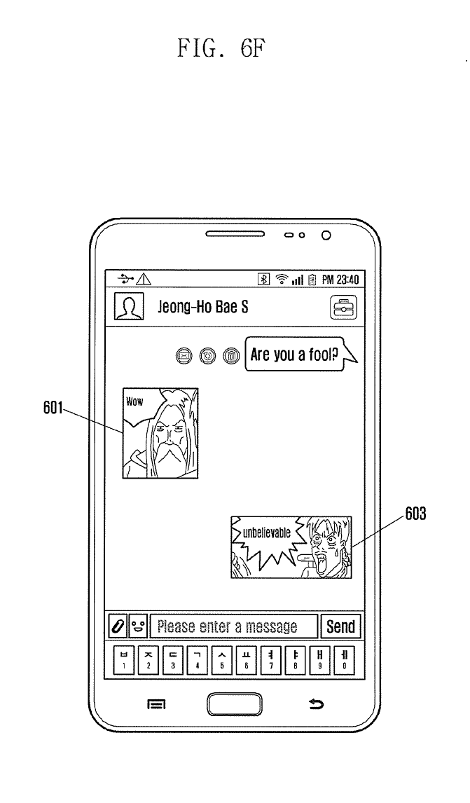

FIG. 5 is a signal flow diagram illustrating a process in which an electronic device uses an emoticon generated by a server according to various embodiments of the present disclosure. FIGS. 6A to 6F are examples of screens for explaining a process in which an electronic device uses an emoticon generated by a server according to various embodiments of the present disclosure.

Referring to FIG. 1, FIG. 5, and FIGS. 6A to 6F, in operation 501, the server 200 generates an emoticon as described above with reference to FIGS. 3A and 3B. In operation 503, the server 200 maintains a state where the generated emoticon is stored in the emoticon storage unit 205. As illustrated in FIG. 6A, the server 200 stores, in the emoticon storage unit 205, each emoticon formed from an image file and a representative value (i.e., a key value) corresponding to the image file. Accordingly, an emoticon stored in the emoticon storage unit 205 includes multiple image files under one representative value.

For example, when a representative value is equal to “wow,” the emoticon storage unit 205 stores image files img1, img2, img3, and the like corresponding to the representative value “wow.”

For example, the image file img1 is an image indicated by reference numeral 610 in FIG. 6B, the image file img2 is an image indicated by reference numeral 620 in FIG. 6B, and the image file img3 is an image indicated by reference numeral 630 in FIG. 6B. The image files are configured to have various sizes within a range satisfying the emoticon generation condition.

As described above, the emoticon stored in the emoticon storage unit 205 is extracted from at least one image region in an e-book. Alternatively, when the stored content is a moving image, the emoticon stored in the emoticon storage unit 205 is each scene in the moving image.

In operation 505, the first electronic device 100 detects the input of text in a text message input window. For example, as illustrated in FIG. 6C, the first electronic device 100 detects the input of the text “wow” and displays the text “wow” in a text message input window 600.

When the text is input, in operation 509, the first electronic device 100 transmits the input text (e.g., “wow”) to the server 200.

For example, a first electronic device 100 detects the input of a character in order of “w,” “o,” and “w” from the user in order to receive the text “wow” as input. The first electronic device 100 transmits the input character to the server 200 whenever each character is input.

In another example, the first electronic device 100 transmits, to the server 200, text that is input at a time point when characters such as “Heo” or “Heok” are completed, at a time point when word spacing is detected, or at a time point when one word is input.

In still another example, when detecting a user input for selecting any one icon (e.g., a button), the first electronic device 100 transmit the input text to the server 200. In certain embodiments, the icon is for displaying an emoticon list.

When receiving the input text, in operation 511, the server 200 searches for an emoticon corresponding to the received text. The server 200 searches the emoticon storage unit 205 for an emoticon corresponding to the text “wow” that the first electronic device 100 has received as input.

In various embodiments, in order to search for the emoticon corresponding to the input text, the first electronic device 100 changes the input text to a representative value and transmits the representative value, to which the input text is changed, to the server 200. Accordingly, when receiving the text, which is changed to the representative value, from the first electronic device 100, the server 200 searches for an emoticon corresponding to the representative value. For example, the server 200 changes the input text “wow,” “what,” “amazing,” and the like to a representative value of “wow” and searches for an emoticon corresponding to the representative value.

In another embodiment, when the first electronic device 100 transmits the input text, the server 200 changes the received text to a representative value (e.g., a representative phase). Accordingly, the server 200 searches for the emoticon corresponding to the input text by using the representative value. For example, the server 200 changes text, such as “wow,” “what,” “amazing,” and the like, to a representative value of “wow” and searches for an emoticon corresponding to the representative value.

This is because although pieces of text are differently represented, the different pieces of text indicate the same meaning and thus it may be necessary to change the input text to a representative value.

In operation 513, the first electronic device 100 receives an emoticon list from the server 200 according to a result of searching for the emoticon. The emoticon list includes at least one emoticon corresponding to the input text.

As described above, the first electronic device 100 searches for an emoticon through the server 200. However, in order to increase a search speed, the first electronic device 100 searches for an emoticon in the emoticon storage unit 121 of the storage unit 120 of the first electronic device 100. Specifically, an emoticon generated by the server 200 is stored in the emoticon storage unit 205 of the server 200, but a predetermined number of emoticons from among the generated emoticons are stored in the emoticon storage unit 121 of the electronic device 100, in order to increase an emoticon search speed.

In operation 515, the first electronic device 100 displays a result of searching for the emoticon which has been received from the server 200, as illustrated in FIG. 6D. For example, the first electronic device 100 displays an emoticon list corresponding to the input text “wow.” The emoticon list includes emoticons 601, 602 and 603 corresponding to the input text “wow.”

In operation 517, the first electronic device 100 detects the selection of at least one of the emoticons 601, 602 and 603 included in the emoticon list. For example, the first electronic device 100 detects the selection of the emoticons 601.

In operation 519, the first electronic device 100 detects an event for transmitting the selected emoticon to the reception electronic device. For example, the reception electronic device is a second electronic device 300. According to various embodiments of the present disclosure, the event for transmitting the selected emoticon is an event for pressing a send button that transmits a text message. According to another embodiment of the present disclosure, the event for transmitting the selected emoticon is an event for selecting at least one of the emoticons 601, 602 and 603 displayed in response to the input text. Accordingly, the first electronic device 100 detects the event for selecting at least one of the emoticons 601, 602 and 603 and simultaneously transmits the selected emoticon to the second electronic device 300.

According to various embodiments of the present disclosure, the first electronic device 100 transmits the emoticon 601 selected from among the emoticons corresponding to the input text “wow.”

According to another embodiment of the present disclosure, the first electronic device 100 transmits, together, the input text “wow.” and the emoticon 601 selected from among the emoticons corresponding to “wow.”

Also, the first electronic device 100 transmits “wow” and the input text other than “wow” together with the selected emoticon.

The first electronic device 100 transmits information on the selected emoticon to the server 200 in order to transmit the emoticon selected in operation 521 to the second electronic device 300. In certain embodiments, the information on the selected emoticon is image file information (e.g., an image file name, an image file number, etc.) of an emoticon corresponding to the selected emoticon. In operation 523, the server 200 transmits, to the second electronic device 300, an image corresponding to the image file information of the selected emoticon. In operation 525, the second electronic device 300 displays the received image, namely, the emoticon.

Simultaneously, the first electronic device 100 displays the selected emoticon 601, as illustrated in FIG. 6E. Also, the first electronic device 100 displays the emoticon 603 received from the second electronic device 300, as illustrated in FIG. 6F. The second electronic device 300 transmits an emoticon in the above-described method. A description thereof will be omitted.

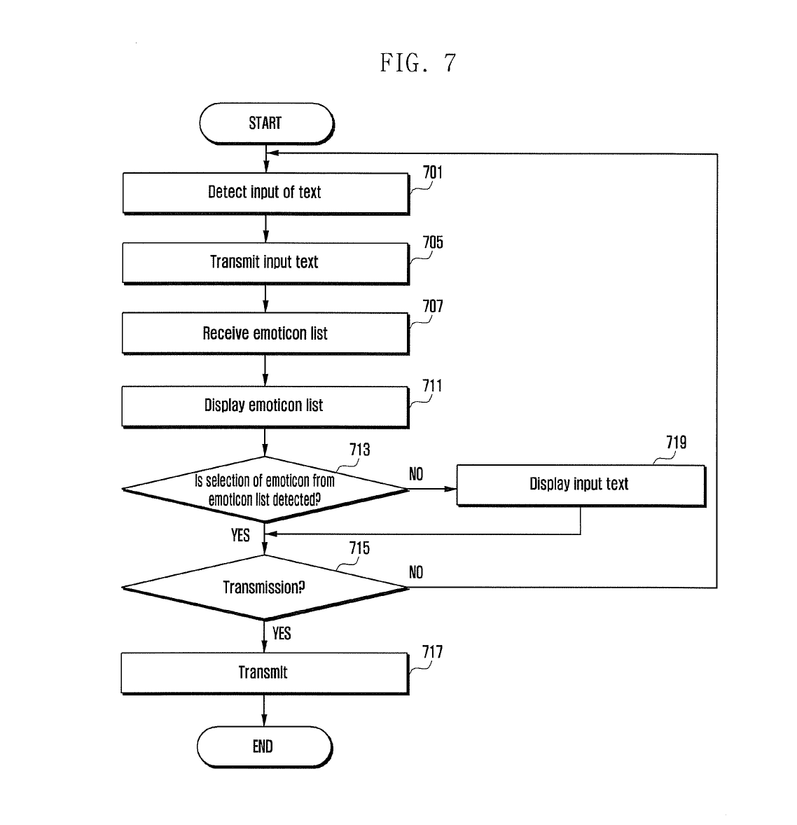

FIG. 7 is a flowchart illustrating a process in which an electronic device, which receives a text message as input, uses a generated emoticon according to various embodiments of the present disclosure.

Referring to FIG. 7, in operation 701, the touch panel 131 of the electronic device 100 detects the input of text, which occurs in the text input window, under the control of the control unit 140. When the input of the text is detected, the control unit 140 controls the display panel 132 to display the input text.

In operation 705, the control unit 140 transmits the input text to the server 200. In order to quickly search for an emoticon, the control unit 140 transmits the input text to the emoticon storage unit 121 included in the storage unit 120. The emoticon storage unit 121 included in the storage unit 120 stores some or all of emoticons generated by the server 200. Also, the control unit 140 transmits the input text to the emoticon storage unit 205 of the server 200.

In operation 707, the control unit 140 receives an emoticon list, which corresponds to the input text, from the emoticon storages 121 and 205. The emoticon list includes at least one emoticon corresponding to the input text.

In operation 711, the control unit 140 performs a control operation for displaying the emoticon list received from the emoticon storage units 121 and 205.

In operation 713, the control unit 140 determines whether an emoticon is selected from the displayed emoticon list. When an emoticon is not selected from the displayed emoticon list, in operation 719, the control unit 140 performs a control operation for displaying the input text. Meanwhile, when an emoticon is selected from the displayed emoticon list, in operation 715, the control unit 140 determines whether an event for transmitting the selected emoticon occurs.

According to various embodiments of the present disclosure, the event for transmitting the selected emoticon is an event for pressing a send button that transmits a text message. According to another embodiment of the present disclosure, the event for transmitting the selected emoticon is an event for selecting at least one of the emoticons 601, 602 and 603 displayed in response to the input text. Accordingly, the first electronic device 100 detects the event for selecting at least one of the emoticons 601, 602 and 603, and simultaneously transmits the selected emoticon to the second electronic device 300.

When the event for transmitting an emoticon has occurred, in operation 717, the control unit 140 transmits the selected emoticon to the reception electronic device. Meanwhile, when the event for transmitting an emoticon has not occurred, the control unit 140 branches to operation 701 and performs a control operation for receiving new text as input.

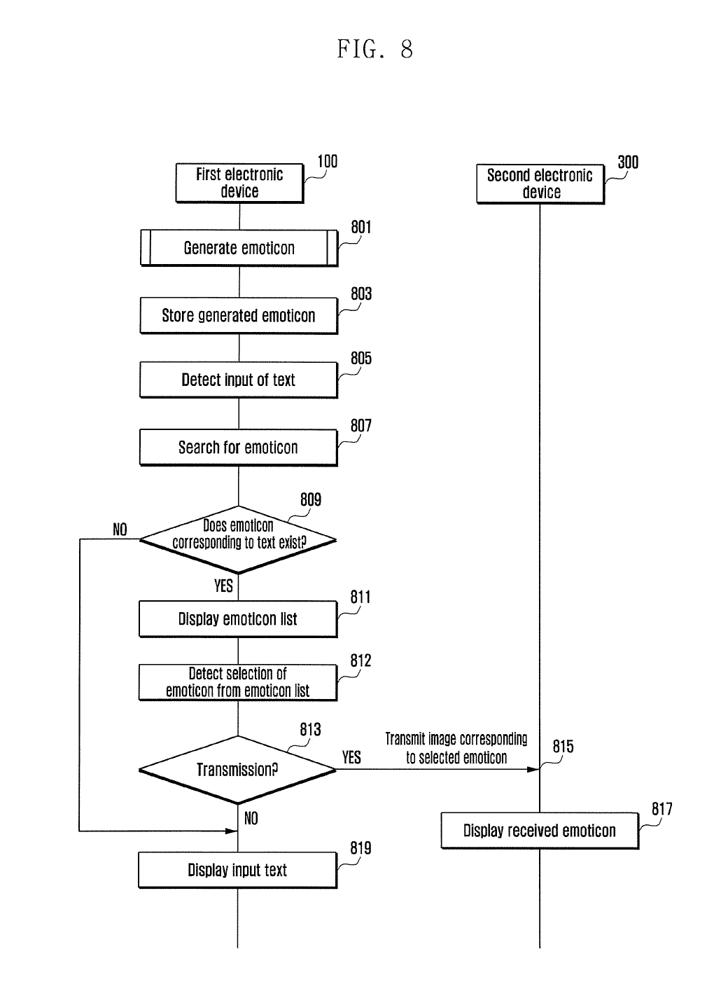

FIG. 8 is a flowchart illustrating a process in which an electronic device uses a generated emoticon according to another embodiment of the present disclosure.

Referring to FIG. 8, in operation 801, the first electronic device 100 generates an emoticon, according to the procedure described with reference to FIG. 3. In operation 803, the first electronic device 100 stores the generated emoticon in the storage unit 120.

In operation 805, the first electronic device 100 detects the input of text which occurs in the text input window. In operation 807, the first electronic device 100 searches for an emoticon corresponding to the input text. In operation 809, the first electronic device 100 determines whether the emoticon corresponding to the input text exists.

According to various embodiments of the present disclosure, the first electronic device 100 searches the storage unit 121 for the emoticon corresponding to the input text.

Meanwhile, when the emoticon corresponding to the input text does not exist, in operation 819, the first electronic device 100 displays the input text.

In operation 811, the first electronic device 100 displays an emoticon list corresponding to the input text, according to a result of the search. The emoticon list includes at least one emoticon corresponding to the input text. In operation 812, the first electronic device 100 detects the selection of an emoticon from the emoticon list. In the present example, the selected emoticon is at least one emoticon.

In operation 813, the first electronic device 100 determines whether the selected emoticon is transmitted. When the transmission of the selected emoticon is not detected, in operation 819, the first electronic device 100 continuously displays the input text. For example, according to the detection of the input of new text, the first electronic device 100 displays the input text. As another example, the first electronic device 100 continuously displays the previously-input text.

Meanwhile, in operation 815, according to the detection of the transmission of an emoticon, the first electronic device 100 transmits the selected emoticon to the reception electronic device. When detecting the selection of the emoticon, in operation 815, the first electronic device 100 transmits an image corresponding to the selected emoticon to the reception electronic device, namely, the second electronic device 300. An emoticon is stored in the emoticon storage unit in the form of an image file and a representative value, and thus, the image corresponding to the selected emoticon is transmitted.

In operation 817, the reception electronic device, namely, the second electronic device 300 displays the received emoticon through this process.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for generating an emoticon in an electronic device, the method comprising:
dividing content into multiple image regions;
extracting an image region corresponding to designated text among the multiple image regions; and
generating an emoticon by using the extracted image region.

2. The method of claim 1, further comprising:
transmitting input text to a server when an input of the text is detected;
receiving an emoticon list corresponding to the input text; and
displaying the received emoticon list.

3. The method of claim 2, wherein transmitting the input text to the server comprises transmitting the input text when the input text forms a word or transmitting the input text when a separate icon for inputting the emoticon is selected.

4. The method of claim 1, wherein extracting the image region corresponding to the designated text comprises:
analyzing the image region by using a text reading unit; and
extracting a particular image region satisfying an emoticon generation condition.

5. The method of claim 1, wherein generating the emoticon further comprises storing the generated emoticon in an emoticon storage unit, wherein the emoticon storage unit is included in a server or the electronic device.

6. The method of claim 5, wherein storing the generated emoticon in the emoticon storage unit comprises:
determining a representative value corresponding to the extracted image region generated as the emoticon; and
storing, in the emoticon storage unit, an image file of the extracted image region and the representative value corresponding to the image file.

7. The method of claim 1, wherein a server performs the generating of the emoticon.

8. The method of claim 1, wherein the content comprises an electronic book (e-book) or a moving image.

9. A method for generating an emoticon in an electronic device, the method comprising:
generating, by a server, an emoticon based on stored content;
storing the generated emoticon in an emoticon storage unit;
receiving input text from the electronic device;
searching for an emoticon corresponding to the input text; and
transmitting an emoticon list, which includes at least one emoticon, to the electronic device according to a result of searching for the emoticon.

10. The method of claim 9, further comprising:
displaying, by the electronic device, the emoticon list including the at least one emoticon received from the server;
detecting selection of at least one emoticon from the emoticon list; and
transmitting the selected emoticon to a reception electronic device.

11. The method of claim 9, wherein searching for the emoticon corresponding to the input text comprises:
changing the input text to a representative value; and
searching for the emoticon, which corresponds to the input text, in the emoticon storage unit by using the representative value.

12. An apparatus for generating an emoticon in an electronic device, the apparatus comprising:
a server configured to:
divide content into multiple image regions,
extract an image region corresponding to designated text among the multiple image regions, and
generate an emoticon by using the extracted image region.

13. The apparatus of claim 12, wherein the server is further configured to:
search for an emoticon corresponding to input text when the server receives the input text from the electronic device, and
transmit, to the electronic device, an emoticon list according to a result of searching for the emoticon.

14. The apparatus of claim 13, wherein the server is further configured to:
change the input text to a representative value, and
search for the emoticon, which corresponds to the input text, by using the representative value.

15. The apparatus of claim 12, wherein the server comprises a text reading unit configured to extract a particular image region from among the divided image regions, and is further configured to extract a particular image region satisfying an emoticon generation condition among the divided image regions through the text reading unit.

16. The apparatus of claim 12, wherein the server is further configured to:
determine a representative value corresponding to the extracted image region generated as the emoticon, and
store an image file of the extracted image region and the representative value corresponding to the image file.

17. The apparatus of claim 12, wherein the content comprises an electronic book (e-book) or a moving image.

18. An apparatus for generating an emoticon in an electronic device, the apparatus comprising:
a storage unit configured to store the emoticon;
a touch panel configured to detect input of text in a text input window;
a display panel configured to display the input text through the touch panel;
a wireless communication unit configured to communicate with a server for searching for an emoticon corresponding to the input text; and
a control unit configured to:
perform a control operation for receiving an emoticon list, which corresponds to the input text, from the server for dividing content into multiple image regions,
extract an image region corresponding to designated text among the multiple image regions, and
generate an emoticon by using the extracted image region.

19. The apparatus of claim 18, wherein the control unit is further configured to:
perform a control operation for transmitting, to the server, an emoticon search signal corresponding to the input text when the input of the text occurs,
receive, from the server, a result of searching for the emoticon corresponding to the emoticon search signal, and
display at least one emoticon corresponding to the input text.

20. The apparatus of claim 18, wherein the content comprises an electronic book (e-book) or a moving image.
